(19) United States
(12) Patent Application Publication
(10) Pub. No.: US 2010/0173045 A1
(43) Pub. Date: Jul. 8, 2010

(54) Cake on a Stick

(76) Inventor: Jessica Cervantes, Miami, FL (US)

Correspondence Address: Adorno & Yoss, LLC, 1349 West Peachtree Street, NE, Suite 1500, Atlanta, GA, 30309, US

(21) Appl. No.: 12/348,562

(22) Filed: Jan. 5, 2009

(51) Int. Cl. A23G 3/50

(52) U.S. Cl. 426/104; 426/390

(57) ABSTRACT

A cake on a stick is prepared by attaching a top edible treat to a bottom edible treat. The bottom edible treat enables consumer with freedom of movement to enhance visual gratification of the top edible treat during consumption. The bottom edible treat is also consumable further enhancing the consumption experience.

### BACKGROUND

Treats such as candy or chocolates attached to sticks enhance the consumption experience by offering the consumer an ability to view the entire treat during consumption. The stick enables a consumer with freedom of movement in turning and rotating the treat as desired. Such a freedom of movement allows the consumer to better view and play with their treat during consumption which enhances the overall experience.

One shortcoming of treats attached to a stick is the inability to consume the stick. The stick portion of the treat is thrown away upon consumption of the edible treat distracting from the overall enjoyment of the treat.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Briefly, embodiments are directed to preparing a cake on a stick, comprising baking of a top edible treat, preparing a bottom edible treat and coupling the top edible treat to the bottom edible treat where the bottom edible treat holds top edible treat during consumption of the top edible treat while holding the bottom edible treat in hand. The top edible treat may be a muffin, a cup cake, a hard cookie, and a brownie. The bottom edible treat may be a hard cookie, a pretzel, a vegetable, a hard candy or a rice crispy. The top edible treat and the bottom edible treat may be attached by an edible connective layer material made by melting the connective layer material, applying the connective layer material to the bottom edible treat, and inserting the top edible treat onto the melted connective layer. The top edible treat and the bottom edible treat may be attached by baking the bottom edible treat in an open container shape for insertion of the top edible treat, baking the top edible treat in a shape that conforms for insertion into the bottom edible treat, and inserting the top edible treat into the bottom edible treat while the bottom surface of the top edible treat is still soft and hardens onto the top surface of the bottom edible treat at room temperature. The top edible treat and bottom edible treat may be attached by inserting the bottom edible treat into the top edible treat to secure the top edible treat for consumption. The top and bottom edible portions may also be baked together, being prepared from different material and baking into different consistencies (typically the bottom portion harder than the top portion).

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1A is a diagram illustrating a top edible treat attached to a bottom edible treat;

FIG. 1B illustrates the top edible treat attached to the bottom edible treat by an edible connective material layer.

FIG. 2 illustrates a cupcake as the top edible treat attached to a pretzel as the bottom edible treat, the bottom edible treat is baked in a shape to encapsulate the top edible treat;

FIG. 3 illustrates a hard candy as the bottom edible treat inserted into a Christmas cookie as the top edible treat to secure the top edible treat during consumption;

FIG. 4 illustrates a cupcake as the top edible treat attached to a candy cane as the bottom edible treat;

FIG. 5 illustrates a brownie as the top edible treat attached to a hard candy as the bottom edible treat;

### DETAILED DESCRIPTION

Treats on sticks enhance consumption of a treat while distracting from overall enjoyment in having a throwaway portion. There is untapped potential in enhancing the enjoyment of a treat by integrating a top edible treat with a bottom edible treat for holding the top edible treat. Holding the bottom edible treat in hand may provide flexibility of movement during consumption of the top edible treat enabling consumer with ability to rotate and move the top edible treat for visual gratification. Held bottom edible treat may also be consumed to further enhance overall consumption experience.

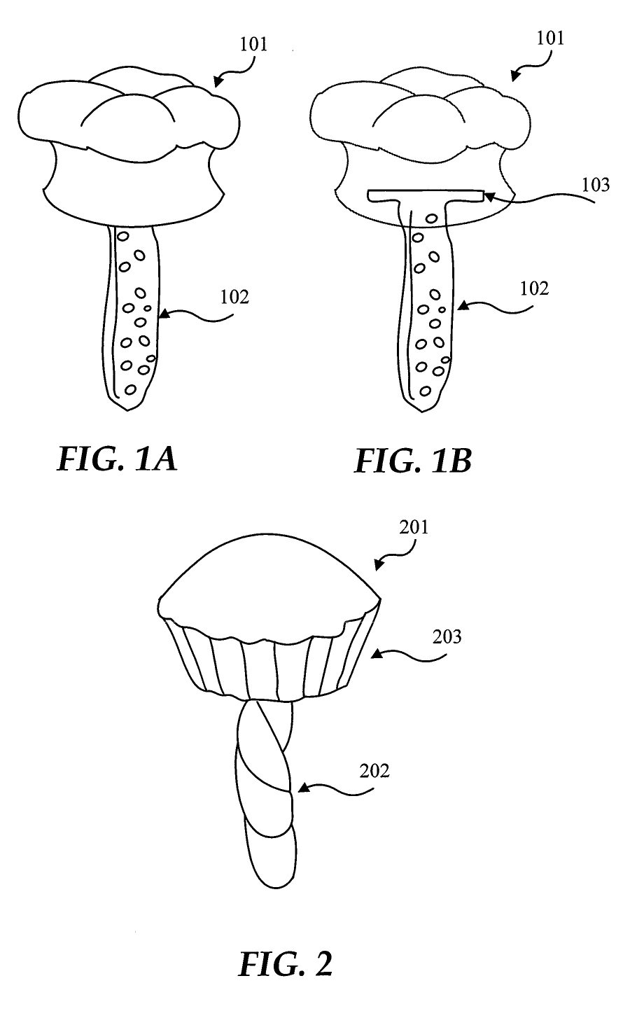

FIG. 1A illustrates a cake on a stick made out of a top edible treat 101 and a bottom edible treat 102. The top edible treat 101 may be a baked good. The bottom edible treat 102 may be a baked good, a vegetable, or similar material. As discussed above the bottom edible treat holds the top edible treat while consuming the top edible treat. Holding the bottom edible treat in hand during consumption allows freedom of movement to rotate and move the top edible treat for enhancing visual gratification. The bottom edible treat is also consumable, which may add to the overall consumption experience.

Embodiments are not limited to the baked goods shown in the above figure as example of a cake on a stick where the top edible treat 101 and the bottom edible treat 102 may be implemented. Using the principles described herein, the top edible treat may be a muffin, a cup cake, a hard cookie, or a brownie. The bottom edible treat may be a hard cookie, a pretzel, a vegetable, a hard candy or a rice crispy.

FIG. 1B illustrates the cake on a stick where the top edible treat 101 and the bottom edible treat 102 may be attached by an edible connective material layer 103. The top edible treat may be attached to the bottom edible treat by melting the edible connective material layer and applying it onto the top portion of the bottom edible treat. The top edible treat may be attached to the bottom edible treat by inserting the bottom portion of the top edible treat onto the melted connective material layer and allowing the connective material layer to solidify at room temperature.

The connective material layer may be a chocolate, a hard candy and a cream. Embodiments are not limited to those connective material layers discussed above.

FIG. 2 illustrates the cake on a stick where the top edible treat 201 may be a cupcake. The bottom edible treat 202 is baked as one piece having a shape to encapsulate the top edible treat 202 within the top portion 203 of the bottom edible treat. The top edible treat may be attached to the bottom edible treat 202 when the top edible treat is recently baked having a soft bottom surface. Inserting the top edible treat into the top portion of the bottom edible treat while the top edible treat still has a soft bottom surface and allowing the cake on a stick to cool to room temperature may enable the bottom surface of the top edible treat to attach to the top surface of the bottom edible treat in a secure manner. Furthermore, the bottom edible treat 202 and top portion 203 may be baked together after attachment. The two portions may be prepared from distinct materials that bake into different consistencies. For example, the top portion 203 may bake into a muffin style treat, while the bottom edible treat may bake into a harder cookie style stick while being baked at the same temperature. Of course, ovens may be designed specially to bake the top portion and the bottom portion at different temperatures such that different consistencies are achieved after baking.

Embodiments are not limited to shapes discussed above. Besides a cupcake shape, the top edible treat 201 and bottom edible 202 treat may be baked in a cylindrical, a cube and a pyramid shape.

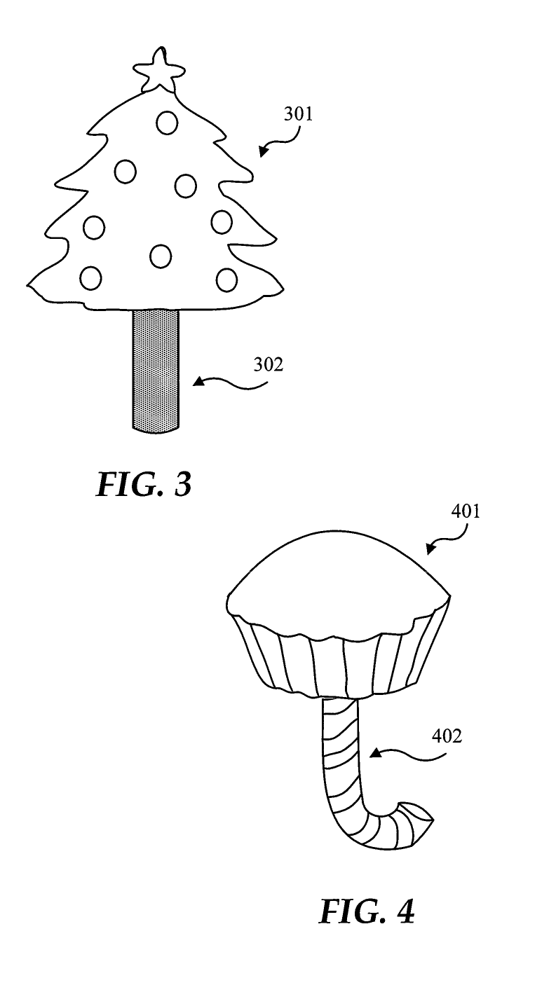

FIG. 3 illustrates the cake on a stick where the top edible treat 301 may be a Christmas cookie. The bottom edible treat 302 may be a hard candy inserted into the top edible treat in order to secure the top edible treat for consumption.

FIG. 4 illustrates the cake on a stick where the top edible treat 401 may be a cupcake. The bottom edible treat 402 may be a candy cane inserted into the top edible treat in a similar fashion as described above.

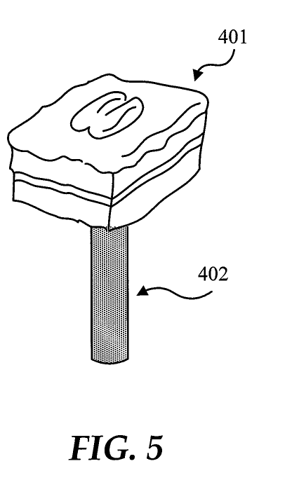

FIG. 5 illustrates the cake on a stick where the top edible treat 501 may be a brownie. The bottom edible treat 502 may be a hard candy inserted into the top edible treat in a similar fashion as described above.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

1. A method for preparing edible treats, comprising:
baking a top edible treat;
preparing a bottom edible treat; and
coupling the top edible treat to the bottom edible treat wherein the bottom edible treat holds top edible treat during consumption of the top edible treat while holding the bottom edible treat in hand.

2. The method of claim 1, wherein the top edible treat is one from a set of a muffin, a cup cake, a hard cookie, and a brownie.

3. The method of claim 2, wherein the bottom edible treat is one from a set of a hard cookie, a pretzel, a vegetable, a hard candy and a rice crispy.

4. The method of claims 3, wherein the top edible treat and the bottom edible treat are attached by an edible connective layer material by:
melting the connective layer material;
applying the connective layer material to the bottom edible treat; and
inserting the top edible treat onto the melted connective layer.

5. The method of claims 3, wherein the top edible treat and the bottom edible treat are attached by:
baking the bottom edible treat in an open container shape for insertion of the top edible treat;
baking the top edible treat in a shape that conforms for insertion into the bottom edible treat; and
inserting the top edible treat into bottom edible treat while the bottom surface of the top edible treat is still soft and hardens onto the top surface of the bottom edible treat at room temperature.

6. The method of claims 3, wherein the top edible treat and bottom edible treat are attached by:
inserting the bottom edible treat into the top edible treat to secure the top edible treat for consumption.

7. A cake on a stick for eating, comprising:
a baked top edible treat;
a bottom edible treat, wherein the top edible treat is coupled to the bottom edible treat such that the bottom edible treat holds the top edible treat during consumption and is designed to be grasped by hand, and wherein the top edible treat is one from a set of: a muffin, a cup cake, a hard cookie, and a brownie and the bottom edible treat is one from a set of: a hard cookie, a pretzel, a vegetable, a hard candy and a rice crispy.

8. The cake on a stick of claim 7, wherein the top edible treat is attached to the bottom edible treat by an edible connective layer material, wherein the connective layer material is first melted, then applied to the bottom edible treat, and then joined with the top edible treat.

9. The cake on a stick of claim 7, wherein the top edible treat and the bottom edible treat are attached after the bottom edible treat is baked in an open container shape for insertion of the top edible treat and the top edible treat is baked in a shape that conforms for insertion into the bottom edible treat, and wherein the top edible treat is inserted while the bottom surface of the top edible treat is still soft and hardens onto the top surface of the bottom edible treat at room temperature.

10. The cake on a stick of claim 7, wherein the top edible treat and the bottom edible treat are attached through the bottom edible treat being inserted into the top edible treat to secure the top edible treat for consumption.

11. The cake on a stick of claim 7, wherein the top edible treat and the bottom edible treat are prepared from distinct materials that bake into distinct consistencies, are attached prior to baking, and baked at the same temperature.

12. The cake on a stick of claim 11, wherein the bottom edible treat is prepared from a material that bakes into a harder consistency compared to the top edible treat.

13. The cake on a stick of claim 12, wherein the bottom edible treat is a hard cookie and the top edible treat is a soft cake.

14. The cake on a stick of claim 7, wherein the top edible treat and the bottom edible treat are prepared from distinct materials that bake into distinct consistencies, are attached prior to baking, and baked at the distinct temperatures in a special oven.

15. A cake on a stick comprising:
a top edible treat coupled to a bottom edible treat after the top edible treat and the bottom edible treat are ready for consumption, wherein the bottom edible treat holds the top edible treat during consumption.

16. The cake on a stick of claim 15, wherein the top edible treat is a cupcake and the bottom edible treat is a hard cookie.

16. (canceled)

17. The cake on a stick of claim 15, wherein the top edible treat is a hard cookie and the bottom edible treat is a rice crispy.

18. The cake on a stick of claim 15, wherein the top edible treat is a hard cookie and the bottom edible treat is a vegetable.

19. The cake on a stick of claim 15, wherein the top edible treat is a hard cookie and the bottom edible treat is a pretzel.

20. The cake on a stick of claim 15, wherein the top edible treat is a cup cake and the bottom edible treat is a pretzel.
